(19) United States
(12) Patent Application Publication
(10) Pub. No.: US 2005/0195883 A1
(43) Pub. Date: Sep. 8, 2005

(54) Method and apparatus for ultra wideband communication

(75) Inventors: Yun-hwa Choi, Seoul (KR); In-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/056,481

(22) Filed: Feb. 14, 2005

(30) Foreign Application Priority Data
Feb. 14, 2004 (KR) 10-2004-0009863

(51) Int. Cl. H04B 1/69

(52) U.S. Cl. 375/130

(57) ABSTRACT

A method and apparatus for Ultra Wideband (UWB) communication, wherein in a UWB transmission method, a codeword stream is generated by performing spread spectrum used in Direct Sequence Code Division Multiple Access (DS CDMA) on a bitstream, followed by performing Orthogonal Frequency Division Multiplexing (OFDM) modulation .on the codeword stream. In a UWB reception method, UWB signals are received and subjected to UWB demodulation to obtain OFDM signals. The obtained OFDM signals are subjected to OFDM demodulation to obtain a codeword stream. Then, spread spectrum used in the DS CDMA is performed on the codeword stream, thereby generating a bitstream. The method and apparatus provide UWB communication having characteristics of both of Multi-Band OFDM (ODM) and Direct Sequence Code Division Multiple Access (DS CDMA).

### CROSS-REFERENCE TO RELATED APPLICATION

This application claims priority from Korean Patent Application No. 10-2004-0009863 filed on Feb. 14, 2004 in the Korean Intellectual Property Office, the disclosure of which is incorporated herein by reference in its entirety.

### BACKGROUND OF THE INVENTION

1. Field of the Invention

The present invention relates to Ultra Wideband (UWB) communication, and more particularly, to a method and apparatus for UWB communication.

2. Description of the Related Art

Recently, UWB communication, which allows high-speed wireless communication without specially securing frequency resources and is compatible with existing wireless communication services, has been studied intensively.

In a broad sense, UWB technology directing to communication using a wide frequency band was started for military purposes in 1950s in the United States. Since 1994 when military security was revoked, the UWB technology has been researched and developed by some venture companies and laboratories for the commercial use. In Feb. 14, 2002, the Federal Communications Commission (FCC) in the United States permitted the commercial use of the UWB technology. At present, an Institute of Electrical and Electronics Engineers (IEEE) 802.15 Working Group (WG) is working on standardization of the UWB technology. The FCC defines a UWB as wireless transmission technology occupying bandwidth more than 20% of a central frequency or a bandwidth greater than 500 MHz. Here, unlike in other communication where a bandwidth is determined based on a point of −3 dB, a bandwidth is determined based on a point of −10 dB. While a baseband signal is transmitted using a carrier wave for data transmission in conventional narrowband communication, data is transmitted using very short baseband pulses of several nanoseconds without using the carrier wave in the UWB technology. Accordingly, a UWB pulse corresponding several nanoseconds in a time domain has a wideband up to several gigaseconds on a frequency spectrum. As a result, the UWB technology uses a remarkably wider frequency band than conventional narrowband wireless communication technology.

Such UWB technology using a very short pulse of several nanoseconds has various characteristics different from conventional narrowband communication technology. In the UWB technology, since signals are transmitted fundamentally using pulses, a frequency bandwidth is increased while power density in a frequency domain is decreased. In other words, communication is possible even below a noise band.

The UWB technology allows ultrahigh-speed transmission can be explained using Shannon's capacity. According to a Shannon limit, a maximum data rate at which data can be transmitted without errors in both of wired and wireless communication systems can define a unique communication channel capacity C for each of provided physical communication channels. In particular, a maximum channel capacity C in a channel that has errors due to noise since an available frequency bandwidth B is limited is expressed by Equation (1):

$$C = B {log}_{2} ( 1 + \frac{S}{N} ) \qquad ( 1 )$$

where B is a channel bandwidth, S is a power of a signal, and N is a power of noise.

It can be inferred from Equation (1) that C linearly increases with respect to B and logarithmically increases due to S/N. In other words, when a bandwidth increases, a maximum channel capacity also increases in proportion to the bandwidth. Since the UWB technology uses a short pulse, i.e., a wavelet, to transmit and receive information, a UWB signal may have a wide bandwidth of about several GHz in the frequency domain. In other words, data can be transmitted at an ultrahigh speed in UWB communication. In addition, since the UWB technology uses a wide bandwidth, communication can be performed with low power. Moreover, the UWB technology allows multi-access and suppresses affect of interference in a multi-path.

The UWB technology can be applied to various fields and particularly to high-speed local communication in an area within several meters to several tens of meters. In countries using UWB communication, output power limits are stipulated to prevent a UWB signal from interfering with existing channels.

FIG. 1 illustrates output power limits stipulated for a UWB signal in the United States and Europe. In the United States, the FCC sets a band for UWB communication to 3.1-10.6 GHz and an output power limit to −41.3 dB. In addition, a power level of the UWB signal is limited to reduce interference in other bands. In particular, the power level is limited very low in a band of 0.96-1.61 GHz for a Global Positioning System (GPS). Similarly, in Europe, a band for UWB communication is set to 3.1-10.6 GHz and an emission power limit is set to −41.3 dBm. Europe is stricter than the United States in stipulating to prevent interference with other bands. The FCC states only about an average power without an instantaneous power with respect to the output power limit.

UWB communication methods satisfying an output power limit are largely classified into two modes: a Multi-Band Orthogonal Frequency Division Multiplexing (MB OFDM) mode in which a band of 3.1-10.6 GHz is divided into bands of 528 MHz and each 528 MHz band is subjected to frequency hopping; and a Direct Sequence Code Division Multiple Access (DS CDMA) mode in which the band of 3.1-10.6 GHz is divided into two 528 MHz bands and a bitstream in each 528 MHz band is replaced with 24-bit codeword.

In the MB OFDM mode, since OFDM is used, frequency resources can be efficiently used, narrowband interference is low, and robustness appears in a multi-path environment. However, since frequency hopping is used, although an average power satisfies the output power limit, an instantaneous power exceeds the output power limit. Accordingly, the MB OFDM is moot. The DS CDMA mode is advantageous in that both of the average power and the instantaneous power do not exceed the output power limit. However, since a small number of bands are used for fast communication, fast baseband processing performance and a mixer and a filter which have a wideband are required.

### SUMMARY OF THE INVENTION

The present invention provides a method and apparatus for Ultra Wideband (UWB) communication, by which both of an average power and an instantaneous power satisfy an output power limit and slow baseband processing is allowed.

According to an aspect of the present invention, there is provided a UWB transmission method including generating a codeword stream by dividing a bitstream into n-bit sets and selecting codewords corresponding the respective n-bit sets, generating Orthogonal Frequency Division Multiplexing (OFDM) signals by performing OFDM modulation on the codeword stream, and generating and outputting UWB signals having a predetermined central frequency by mixing the OFDM signals with carriers.

Each of the codewords included in the codeword stream is determined according to a combination of “n” bits, and the codewords are orthogonal to each other.

Each of the codewords included in the codeword stream is determined according to a combination of n-1 bits among “n” bits, the other one bit among the “n” bits is used to determine whether a phase of a codeword is inverted by 180 degrees, and the codewords are orthogonal to each other.

The OFDM modulation uses Binary Phase Shift Keying (BPSK) for constellation mapping.

The generating and outputting of the UWB signals may comprise generating the carriers respectively having central frequencies of bands, and respectively mixing the OFDM signal with the carriers in the respective bands.

In accordance with another aspect of the present invention, there is provided an Ultra Wideband (UWB) transmitter comprising a look-up table comprising codewords respectively corresponding to n-bit sets into which a bitstream is divided, wherein the codewords are orthogonal to each other, an Orthogonal Frequency Division Multiplexing (OFDM) modulation unit performing OFDM modulation on a codeword stream obtained from the bitstream using the look-up table, thereby generating OFDM signals, a UWB modulation unit generating carriers having a predetermined central frequency and mixing the OFDM signals with the carriers, thereby generating UWB signals, and an antenna emitting the UWB signals to a wireless transmission medium.

The OFDM modulation unit uses Binary Phase Shift Keying (BPSK) for constellation mapping.

The UWB modulation unit may comprise a sine wave generator generating the carriers each of which has a central frequency of a band, and a mixer mixing the OFDM signals with the carriers to generate the UWB signals.

In accordance with still another aspect of the present invention, there is provided an Ultra Wideband (UWB) reception method comprising obtaining Orthogonal Frequency Division Multiplexing (OFDM) signals from received UWB signals, obtaining a codeword stream by performing OFDM demodulation on the OFDM signals, and obtaining a bitstream by finding out “n” bits corresponding to each of codewords comprised in the codeword stream.

The obtaining of the codeword stream may comprise generating a sine wave having the same frequency as a carrier of each of the received UWB signals, and mixing the sine wave with the UWB signal.

The OFDM signals may be generated through constellation mapping based on Binary Phase Shift Keying (BPSK).

The obtaining of the bitstream may comprise obtaining a correlation value by multiplying a codeword comprised in the codeword stream by a codeword comprised in a look-up table and integrating a result of multiplication, comparing the correlation value with a predetermined value, and outputting “n” bits corresponding to the codeword in the look-up table when it is determined that the two codewords are identical.

In accordance with a further aspect of the present invention, there is provided an Ultra Wideband (UWB) receiver comprising an antenna receiving UWB signals transmitted through a wireless transmission medium, a UWB demodulation unit obtaining Orthogonal Frequency Division Multiplexing (OFDM) signals from the received UWB signals, an OFDM demodulation unit obtaining a codeword stream from the OFDM signals, and a correlation unit obtaining a bitstream from the codeword stream.

The UWB demodulation unit may comprise a sine wave generator generating a sine wave having the same frequency as a carrier of each of the received UWB signals, and a mixer mixing the sine wave with the UWB signal.

The OFDM signals are generated through constellation mapping based on Binary Phase Shift Keying (BPSK).

The correlation unit finds out “n” bits corresponding to each of codewords comprised in the codeword stream and comprises a look-up table storing codewords to be multiplied by the codewords comprised in the codeword stream, a correlation value extractor multiplying a codeword comprised in the codeword stream by a codeword stored in the look-up table and integrating a result of the multiplication, thereby obtaining a correlation value, and a determiner comparing the correlation value with a predetermined value to determine whether the two codewords are identical, and outputting “n” bits corresponding to the codeword in the look-up table when the two codewords are determined as being identical.

### BRIEF DESCRIPTION OF THE DRAWINGS

The above and other aspects of the present invention will become more apparent by describing in detail exemplary embodiments thereof with reference to the attached drawings in which:

FIG. 1 illustrates output power limit masks for an Ultra Wideband (UWB) signal in the United States and Europe;

FIG. 2 illustrates UWB frequency band allocation in a Multi-Band Orthogonal Frequency Division Multiplexing (MB OFDM) mode;

FIG. 3 is a functional block diagram of an MB OFDM transmitter;

FIG. 4 illustrates UWB frequency band allocation in a Direct Sequence Code Division Multiple Access (DS CDMA) mode;

FIG. 5 is a functional block diagram of a DS CDMA transmitter;

FIG. 6 illustrates UWB frequency band allocation according to an exemplary embodiment of the present invention;

FIG. 7 is a functional block diagram of a UWB transmitter according to an exemplary embodiment of the present invention;

FIG. 8 illustrates conception of an orthogonal signal;

FIGS. 9A, 9B and 9C illustrate conception of M-Binary Orthogonal Keying (M-BOK);

FIG. 10 is a functional block diagram of a UWB receiver according to an exemplary embodiment of the present invention; and

FIG. 11 is a detailed functional block diagram of a correlation unit shown in FIG. 10.

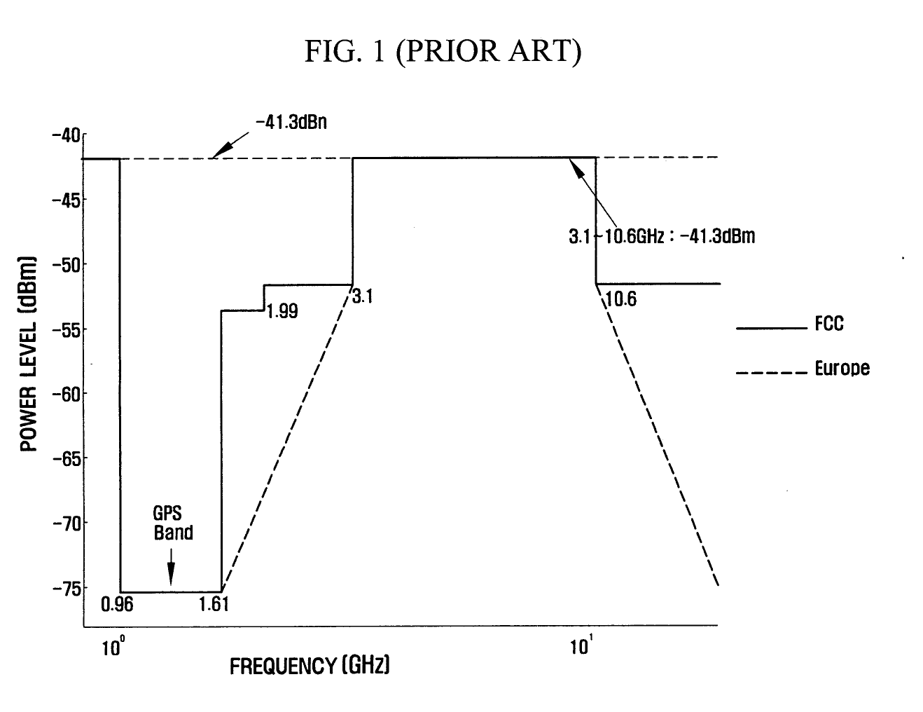

### DETAILED DESCRIPTION OF THE EXEMPLARY EMBODIMENTS THE INVENTION

Exemplary embodiments of the present invention will now be described with reference to the accompanying drawings.

The present invention fundamentally has characteristics of both of Ultra Wideband (UWB) communication in a Multi-Band Orthogonal Frequency Division Multiplexing (MB OFDM) mode and UWB communication in a Direct Sequence Code Division Multiple Access (DS CDMA) mode. In other words, the present invention uses OFDM of the MB OFDM mode but does not use frequency hopping of the MB OFDM mode. To achieve an effect of spread spectrum due to the frequency hopping, spread spectrum used in the DS CDMA is used. Hereinafter, descriptions of the MB OFDM mode and the DS CDMA mode will be set forth before UWB communication according to exemplary embodiments of the present invention is described.

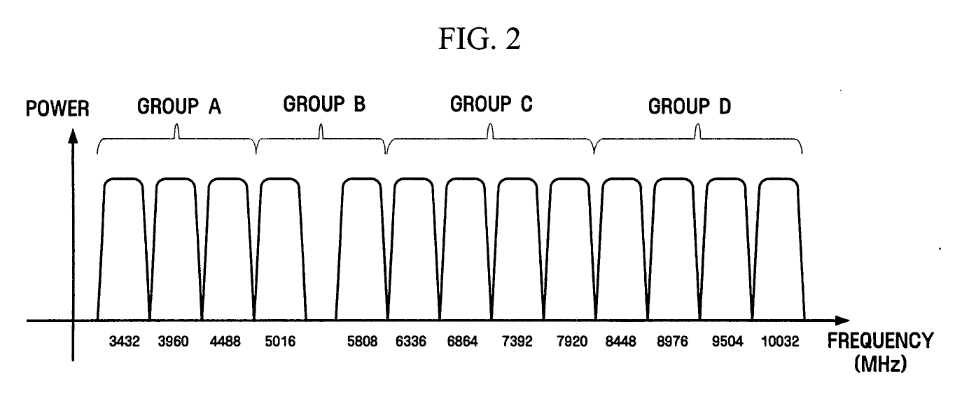

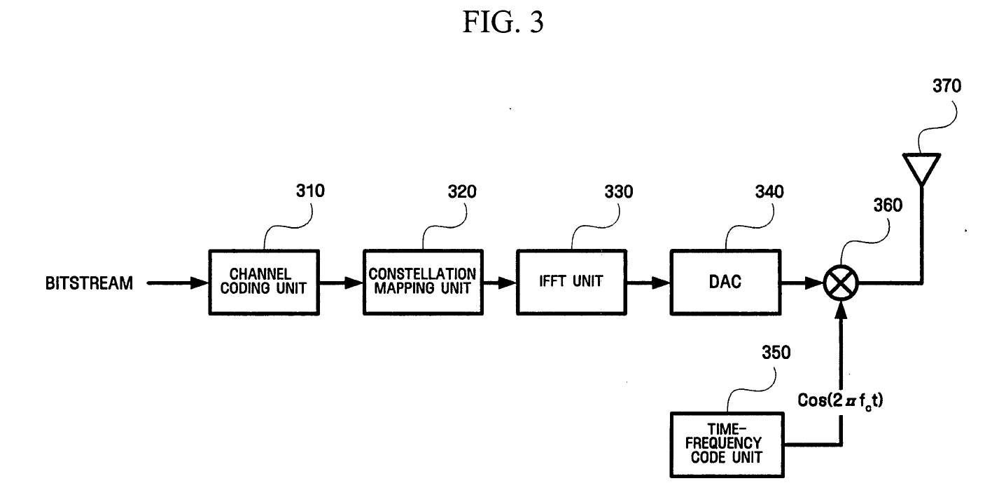

In the MB OFDM mode, a band of 3.1-10.6 GHz is divided into bands of 528 MHz. In each 528 MHz band, information is transmitted using OFDM. OFDM carriers are effectively generated using Inverse Fast Fourier Transform/Fast Fourier Transform (IFFT/FFT). Information bits are embedded in all of the 528 MHz bands so that frequency diversity can be used and robustness to a multi-path and interference can be achieved. A 60.6 ns prefix can provide robustness in a worst channel environment. A 9.5 ns guard interval provides sufficient time to switch between 528 MHz bands. UWB frequency allocation in the MB OFDM mode will be described with reference to FIG. 2 and an MB OFDM transmitter will be described with reference to FIG. 3 below.

FIG. 2 illustrates UWB frequency band allocation in the MB OFDM mode.

A frequency band is divided into bands of 528 MHz. The 528 MHz bands are classified into four groups, as shown in FIG. 2. In group B, there is a frequency range that is not used because a band is not allocated to prevent interference with Wireless Local Area Network (WLAN). Group A is provided for first-generation equipment and includes three 528 MHz bands. Central frequencies of the three 528 MHz bands are 3432 MHz, 3960 MHz, and 4488 MHz, respectively. The group A has a frequency band of 3.1-4.9 GHz.

The group B is reserved for future use and includes two 528 MHz bands. An empty portion between the two 528 MHz bands is given to prevent interference with Institute of Electrical and Electronics Engineers (IEEE) 802.11a devices. The group B has a frequency band of 4.9-6.0 GHz.

Group C is provided for devices having improved System On Package (SOP) performance and includes four 528 MHz bands. The group C has a frequency band of 6.0-8.1 GHz.

Group D is reserved for future use and has a frequency of 8.1-10.6 GHz.

FIG. 3 is a functional block diagram of the MB OFDM transmitter.

The MB OFDM transmitter includes a channel coding unit 310, a constellation mapping unit 320, an IFFT unit 330, a digital-to-analog converter (DAC) 340, a time-frequency code unit 350, a mixer 360, and an antenna 370.

The channel coding unit 310 adds redundant bits to a bitstream to recover a signal that may be lost during transmission. To prevent a burst error, a sequence of the bitstream may be scrambled and then convolution coded. When a ratio of the redundant bits to the bitstream increases, a chance of an error occurring during transmission via a channel being recovered also increases. A rate of bits containing information in a channel-coded bitstream is referred to as a channel coding rate. The channel coding rate is 1 when no redundant bits are added to a bitstream at all and is 1/2 when a proportion of redundant bits is the same as that of information bits. The channel coding rate can be appropriately selected in accordance with an environment of a transmission channel and may be 1/3, 2/3, or 3/4 besides 1/2.

The constellation mapping unit 320 maps channel-coded bits in accordance with a type of modulation. When Binary Phase Shift Keying (BPSK) modulation is used, a single bit is mapped to a single BPSK symbol. When Quadrature Phase Shift Keying (QPSK) modulation is used, two bits are mapped to a single QPSK symbol. For example, in BPSK mapping, a bit value may be set to “0” when a phase is 0 degrees and may be set to “1” when the phase is 180 degrees. Besides, when 16 Quadrature Amplitude Modulation (QAM) is used, four bits may be mapped to a single symbol. When 32 QAM is used, five bits may be mapped to a single symbol. When 64 QAM is used, six bits may be mapped to a single symbol. When many bits are mapped to a single symbol, a data transmission rate increases but a probability of an error occurring during data transmission/reception adversely increases. Accordingly, in the MB OFDM mode, modulation is limited to BPSK and QPSK.

The channel-coded bitstream is input to and mapped by the constellation mapping unit 320. The constellation mapping unit 320 inputs 128 mapped symbols to the IFFT unit 330 in parallel at one time. The IFFT unit 330 receives the 128 mapped symbols, produces 128 sampled waves in a time domain, and generates a single sampled OFDM signal by summing the 128 sampled waves. The sampled OFDM signal is converted to an analog OFDM signal by the DAC 340.

The analog OFDM signal is mixed with a carrier in each 528 MHz band by the mixer 360, thereby generating a UWB signal. The UWB signal is emitted to a wireless medium via the antenna 370.

The time-frequency code unit 350 generates carriers multiplied by the analog OFDM signal. When the carriers are generated, band hopping is performed. For example, in the group A shown in FIG. 2, a carrier having a frequency of 3432 MHz is generated; after a guard interval of 9.5 ns, a carrier having a frequency of 3960 MHz is generated; and after the 9.5 ns guard interval, a carrier having a frequency of 4488 MHz is generated. In this case, a first OFDM signal becomes a UWB signal having a central frequency of 3432 MHz, a second OFDM signal becomes a UWB signal having a central frequency of 3960 MHz, and a third OFDM signal becomes a UWB signal having a central frequency of 4488 MHz. If only bands in the group A are used, fourth, fifth, and sixth OFDM signals become UWB signals having central frequencies of 3432 MHz, 3960 MHz, and 4488 MHz, respectively.

Hopping may be performed in a sequence of 3432 MHz, 3960 MHz, and 4488 MHz or in a sequence of 3432 MHz, 4488 MHz, and 3960 MHz.

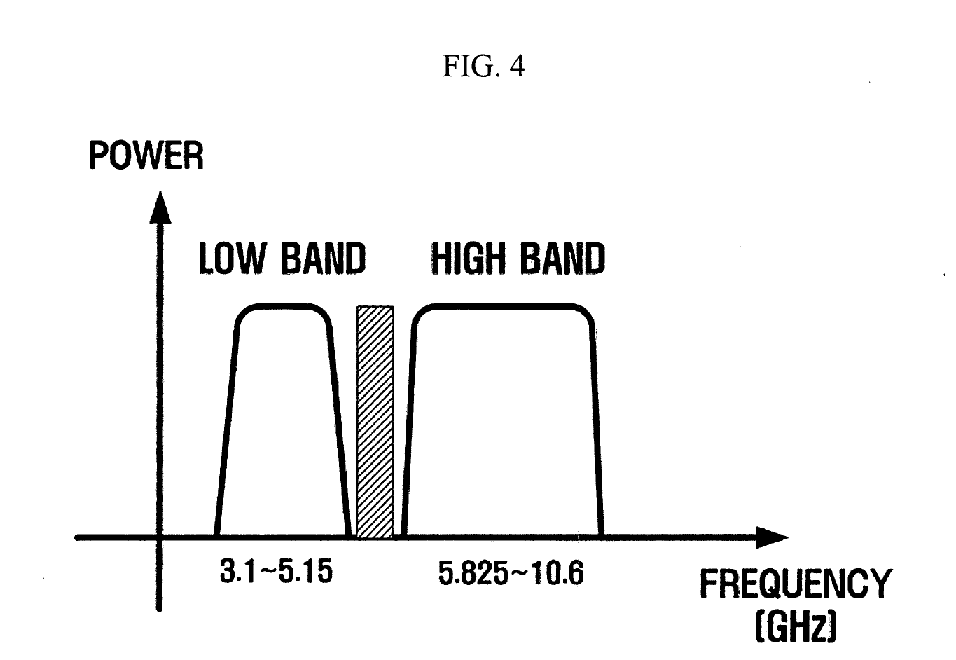

In the DS CDMA mode, a band of 3.1-10.6 GHz is divided into a band of 3.1-5.15 GHz and a band of 5.825-10.6 GHz. In each divided band, a bitstream is spread using DS CDMA and is mixed with a carrier, thereby generating a UWB signal. The UWB signal is emitted to a wireless channel. Unlike mobile communication using pseudo noise, in the DS CDMA mode, when one or more bits are input, a codeword corresponding to the one or more bits in a table including codewords orthogonal to each another is output. A codeword to which bits are mapped includes a plurality of ternary codes. A ternary code has a value among three values 1, −1, and 0. UWB frequency allocation in the DS CDMA mode will be described with reference to FIG. 4.

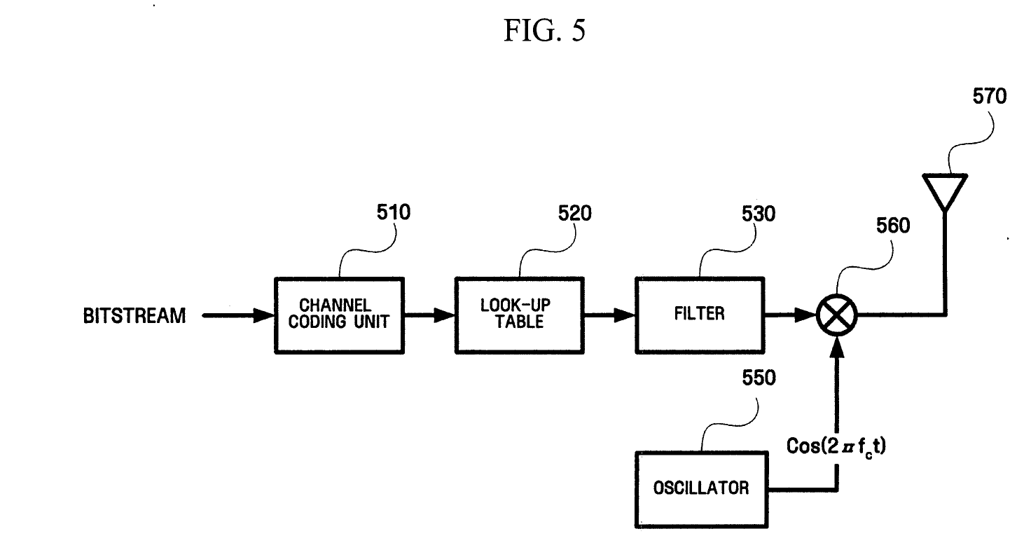

A DS CDMA transmitter will be described with reference to FIG. 5 below.

FIG. 4 illustrates UWB frequency band allocation in the DS CDMA mode.

A frequency band is divided into two bands, a low band and a high band. The low band has a frequency band of 3.1-5.15 GHz and the high band has a frequency band of 5.825-10.6 GHz. A hatched portion between the low band and the high band is not allocated to reduce interference with a WLAN.

In the DS CDMA, either or both of the low band and the high band may be used.

FIG. 5 is a functional block diagram of the DS CDMA transmitter.

The DS CDMA transmitter includes a channel coding unit 510, a look-up table 520, a filter 530, an oscillator 550, a mixer 560, and an antenna 570.

Like in the MB OFDM mode, the channel coding unit 510 adds redundant bits to a bitstream to recover a signal that may be lost during transmission. A channel coding rate can be appropriately selected in accordance with an environment of a transmission channel and may be 1/2, 1/3, 2/3, or 3/4.

Upon receiving a coded bitstream, the look-up table 520 outputs a codeword per a predetermined number of bits. A single codeword includes 24 ternary codes. For example, if a codeword is output per two bits, the look-up table 520 includes four groups of codewords orthogonal to each other.

The filter 530 is implemented by a Root Raised Cosine (RRC) filter and filters codewords. A codeword in the low band had a central frequency of 684 MHz and a codeword in the high band has a central frequency of 1.368 GHz.

The oscillator 550 generates a carrier to be multiplied by a filtered codeword. The oscillator 550 generates a carrier having a frequency of 4.104 GHz for a codeword in the low band and a carrier having a frequency of 8.208 GHz for a codeword in the high band.

The mixer 560 mixes a carrier generated by the oscillator 550 with a filtered codeword output from the filter 530, thereby generating a UWB signal.

The UWB signal is emitted to a wireless channel via the antenna 570.

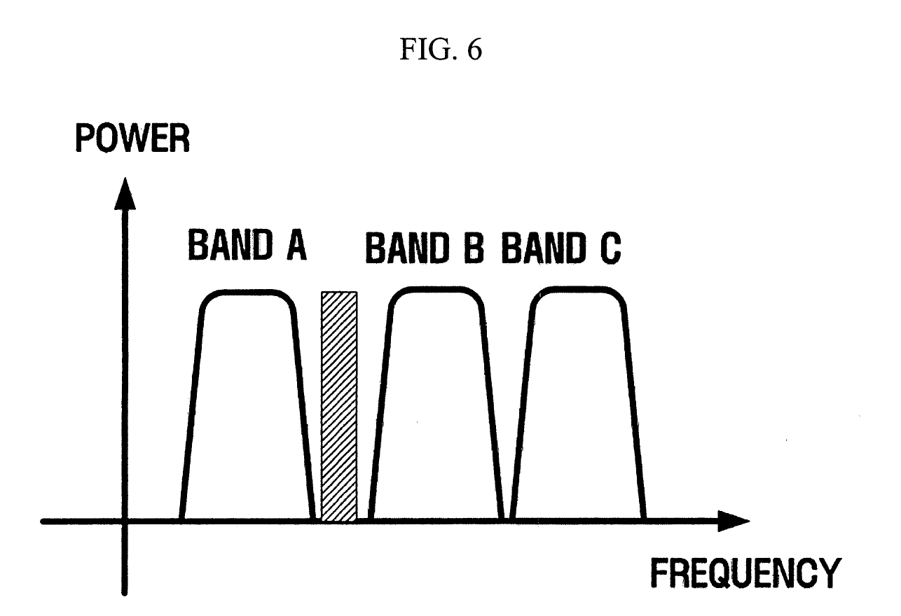

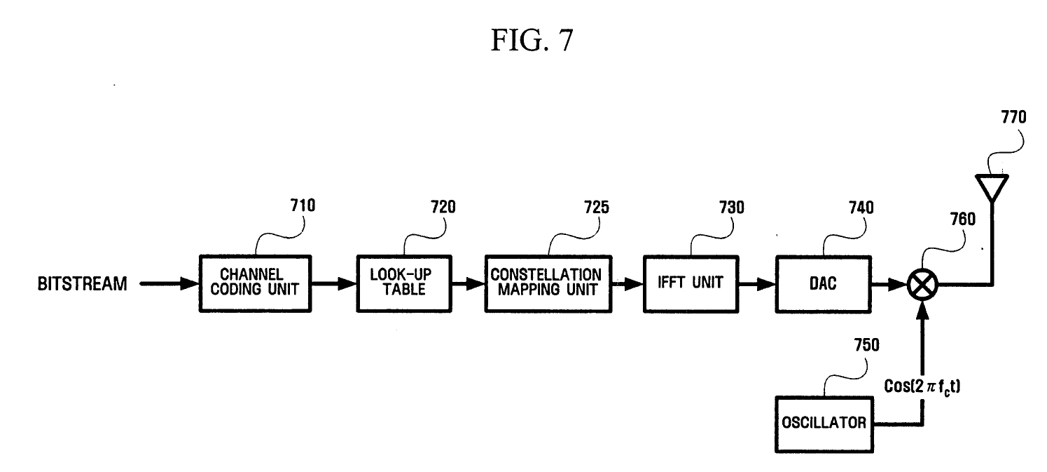

The present invention has characteristics of both of OFDM and DS CDMA, which will be described with reference to FIGS. 6 and 7.

FIG. 6 illustrates UWB frequency band allocation according to an exemplary embodiment of the present invention.

In the illustrative exemplary embodiment of the present invention, a frequency band is divided into three bands A, B, and C. In each of the bands A, B, and C, information is transmitted using OFDM. The reason that the frequency band is divided into the three bands A, B, and C is that there is a frequency band between the band A and the band B which is not allocated to prevent interference with a WLAN, the frequency band spontaneously divides an entire band into two portions, and a portion in a high frequency band is about double a portion in a low frequency band. Alternatively, the band A may be divided into smaller bands and the bands B and C may also be divided into smaller bands. OFDM carriers are effectively generated using 512-point IFFT. OFDM with 512 sub-carriers is used because the exemplary embodiment of the present invention uses a band greater than 2 GHz compared to the MB OFDM mode using a 528 MHz band. Like the MB OFDM mode, the exemplary embodiment of the present invention uses a 60.6 ns prefix. However, the exemplary embodiment of the present invention does not use frequency hopping, and therefore, it may not use a guard interval. Instead of using the frequency hopping, bits of a signal that has been spread using CDMA are input to generate an OFDM signal.

A structure of a UWB transmitter according to an exemplary embodiment of the present invention will be described with reference to FIG. 7.

Referring to FIG. 7, the UWB transmitter includes a channel coding unit 710, a look-up table 720, a constellation mapping unit 725, an IFFT unit 730, a DAC 740, an oscillator 750, a mixer 760, and an antenna 770.

The channel coding unit 710 adds redundant bits to a bitstream to recover a signal that may be lost during transmission.. To prevent a burst error, a sequence of the bitstream may be scrambled and then convolution coded.

The look-up table 720 receives a channel-coded bitstream and outputs a codeword stream (i.e., codewords). Codewords in the look-up table 720 will be described later. The codeword stream is modulated using OFDM. OFDM modulation is performed using the constellation mapping unit 725, the IFFT unit 730, and the DAC 740.

The constellation mapping unit 725 maps input codewords in accordance with a type of modulation. When BPSK modulation is used, a single bit is mapped to a single BPSK symbol. When QPSK modulation is used, two bits are mapped to a single QPSK symbol. For example, in BPSK mapping, a bit value may be set to “0” when a phase is 0 degrees and may be set to “1” when the phase is 180 degrees. To reduce a probability of error occurrence, the BPSK modulation is used.

The constellation mapping unit 725 inputs 512 mapped symbols to the IFFT unit 730 in parallel at a time. The IFFT unit 730 receives the 512 mapped symbols, produces 512 sampled waves in a time domain, and generates a single sampled OFDM signal by summing the 512 sampled waves. The sampled OFDM signal is converted to an analog OFDM signal by the DAC 740.

The oscillator 750 generates a carrier used to generate a UWB signal in each band. If only the band A is used, the oscillator 750 generates a carrier having a central frequency of the band A. If the bands A and B are used, a carrier having the central frequency of the band A and a carrier having a central frequency of the band B are generated. In other words, the oscillator 750 generates a carrier corresponding to a used band.

A UWB signal is generated using the oscillator 750 and the mixer 760. The OFDM signal is mixed with a carrier in a corresponding band by the mixer 760, thereby generating a UWB signal in the band. The UWB signal is emitted to a wireless medium via the antenna 770.

In the exemplary embodiment of the present invention, frequency hopping is not used. Accordingly, when a plurality of bands are used, a bitstream is divided to be transmitted through different channels. In each channel, a codeword is generated with respect to a bitstream to be transmitted through the channel. The codeword is sequentially subjected to IFFT and digital-to-analog conversion and then mixed with a carrier of a corresponding band, thereby generating a UWB signal.

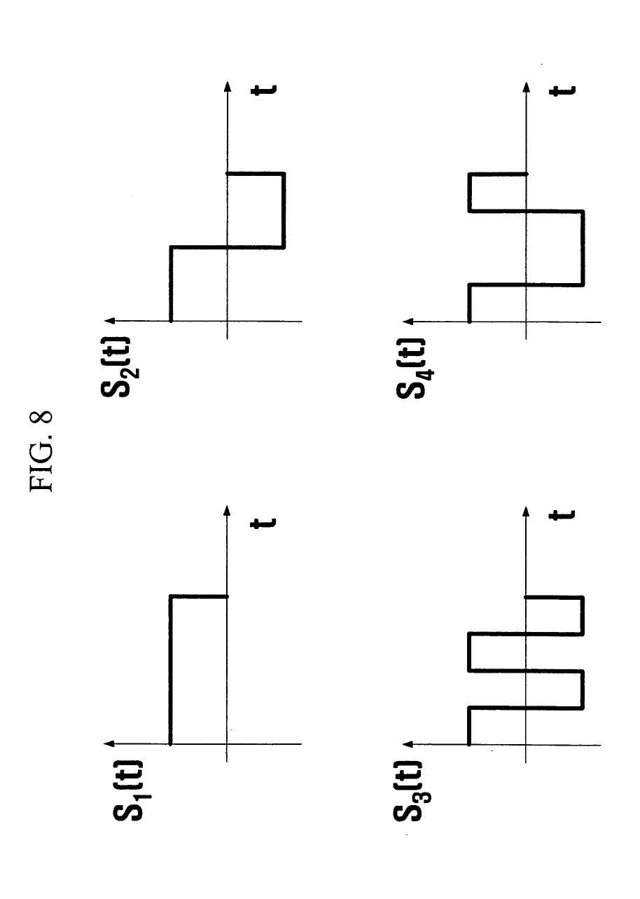

Codewords are orthogonal or nearly orthogonal to each other. Conception of “orthogonal” will be described with reference to FIG. 8.

FIG. 8 illustrates conception of an orthogonal signal.

Specifically, FIG. 8 shows four orthogonal signals selected from among 4-bit signals as examples. A total of 2⁴ 4-bit signals are present. Among those 4-bit signals, at least four orthogonal signals can be selected, as shown in FIG. 8. When two signals are orthogonal to each other, integration of a product of the two signals during a single period results in “0”. According to orthogonal keying, when “00” is input, S₁(t) is output. When “01 is input, S₂(t) is output. When “10” is input, S₃(t) is output. When “11” is input, S₄(t) is output. Inputs and outputs may be different.

An orthogonal signal may further include single bit information by way of changing a phase by 180 degrees. For example, when the input “00” is mapped to the output S₁(t)=“1111”, if “000” with an additional sign bit is input, S₁(t)=“1111” is output. If “100” is input, a sign of a signal is changed, and therefore, −S₁(t)=“−1−1−1−1” is output. Such a process of adding a bit to an orthogonal signal by changing a phase of the signal is referred to as Bi-Orthogonal Keying (BOK).

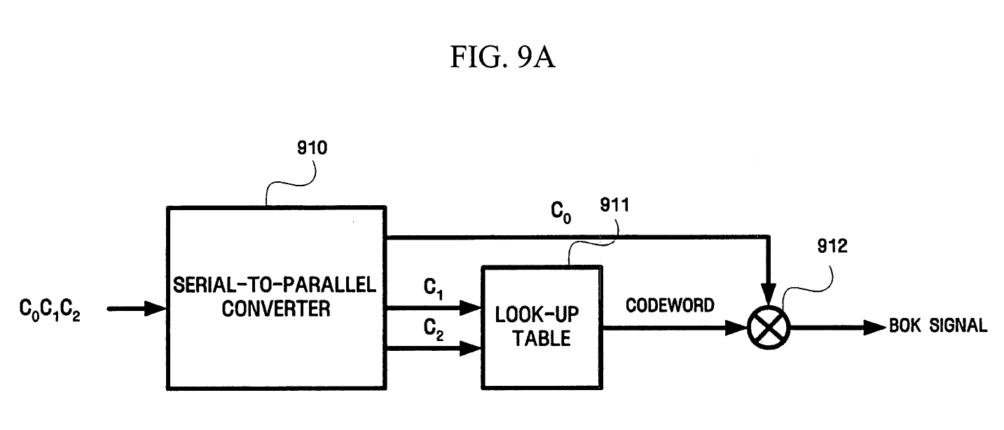

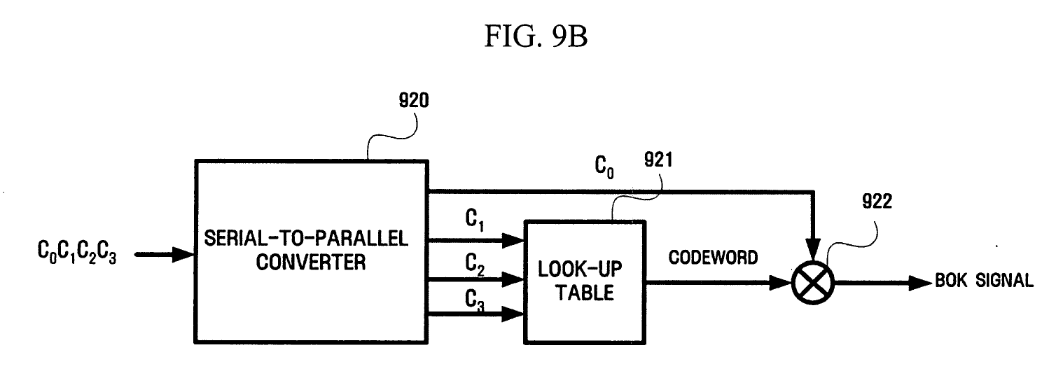

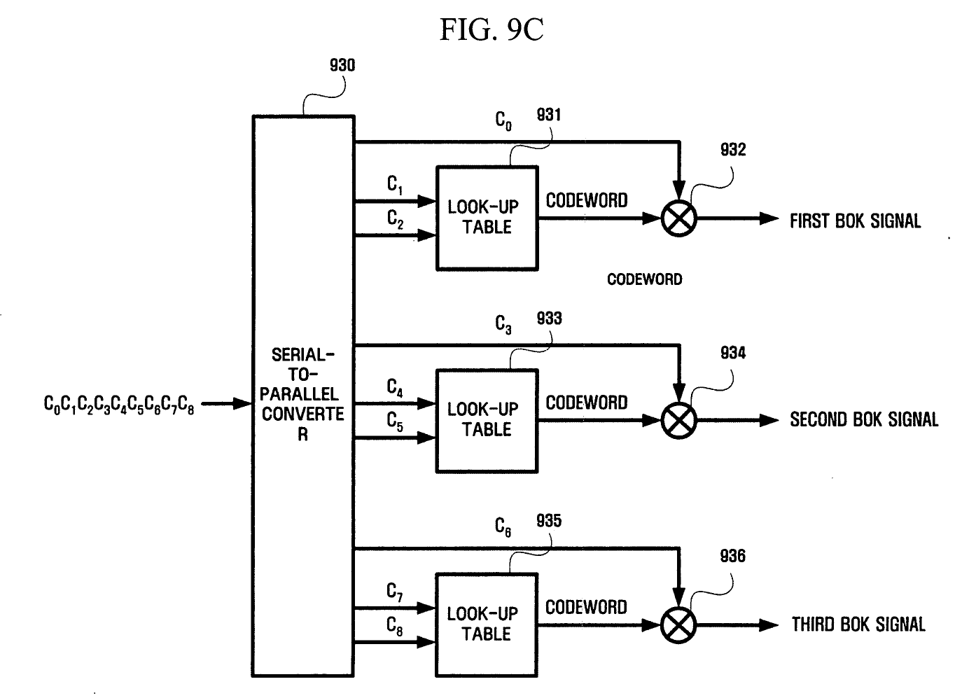

In the exemplary embodiment of the present invention, BOK may be used in mapping by a look-up table. In an exemplary embodiment of the present invention, a BOK signal may include binary bits instead of ternary codes used in the DS CDMA mode, so that constellation mapping can be performed after the mapping using the look-up table. When ternary codes are used, constellation mapping may be performed like a bit “0” is mapped to a phase of 0 degrees, a bit “1” is mapped to a phase of 120 degrees, and a bit “−1” is mapped to a phase of −120 degrees. When a number of pieces of information expressed using bits (=n) mapped to a single codeword is M (=2ⁿ), M-Binary Orthogonal Keying (M-BOK) is used. Conception of the M-BOK will be described with reference to FIGS. 9A, 9B, and 9C.

FIGS. 9A, 9B and 9C illustrate the conception of the M-BOK.

A look-up table using 8-BOK for a single band is shown in FIG. 9A. A look-up table using 16-BOK for a single band is shown in FIG. 9B. A look-up table using 8-BOK for three bands is shown in FIG. 9C. When the 8-BOK is used, a single codeword is output with respect to three bits. When the 16-BOK is used, a single codeword is output with respect to four bits.

Referring to FIG. 9A, three bits C₀, C₁, and C₂ input in series to a serial-to-parallel converter 910 are output in parallel. The two bits C₁ and C₂ are input to a look-up table 911 and the bit C₀ is input to a multiplier 912. The look-up table 911 outputs a codeword corresponding to the bits C₁ and C₂. Codewords stored in the look-up table 911 are orthogonal or nearly orthogonal to each other and are classified into four groups. One group among the four groups is selected according to values of the bits C₁ and C₂ and one codeword among codewords in the selected group is output. If a plurality of codewords are present in one group, UWB communication can be performed between devices in different piconets without cross-talk. A codeword includes “n” chips each of which may be a binary code. For example, a single chip may have a value of “1” or “−1”.

Meanwhile, the bit C₀ input to the multiplier 912 may change a sign of the codeword mapped by the bits C₁ and C₂. For example, in a case where a codeword includes 8 chips and a codeword mapped by the bits C₁ and C₂ is “11111111”, when the bit C₀ is “0”, the codeword may be output as it is (that is, the codeword may be multiplied by “1”). When the C₀ is “1”, the codeword may be multiplied by “−1”, and thus, “−1−1−1−1−1−1−1−1” is output.

Referring to FIG. 9B, a serial-to-parallel converter 920, a look-up table 921, and a multiplier 922 operate in similar manners to the serial-to-parallel converter 910, the look-up table 911, and the multiplier 912 shown in FIG. 9A. However, a 4-bit stream C₀C₁C₂C₃ identifying one among 16 cases is input in series to the serial-to-parallel converter 920 and codewords in the look-up table 921 are classified into eight groups. The number of chips included in a single codeword used in the 16-BOK may be the same as that used in the 8-BOK illustrated in FIG. 9A.

Referring to FIG. 9C, a serial-to-parallel converter 930, look-up tables 931, 933, and 935, and multipliers 932, 934, and 936 operate in similar manners to the serial-to-parallel converters 910 and 920, the look-up tables 911 and 921, and the multipliers 912 and 922 shown in FIGS. 9A and 9B. However, a 9-bit stream C₀C₁C₂C₃C₄C₅C₆C₇C8 is input in series to the serial-to-parallel converter 930 and codewords in each of the look-up tables 931, 933, and 935 are classified into four groups.

Unlike in the 8-BOK and the 16-BOK illustrated in FIGS. 9A and 9B, respectively, when a single bitstream is input, three BOK signals are output in the 8-BOK illustrated in FIG. 9C. Each BOK signal may be used to generate a UWB signal in each band. However, three first BOK signals may be generated using the 8-BOK illustrated in FIG. 9. In this case, three OFDM signals are output from the IFFT unit 730 at a time. A UWB signal including one OFDM signal in one band is output, and therefore, a total of three UWB signals including three OFDM signals in three bands, respectively, are output.

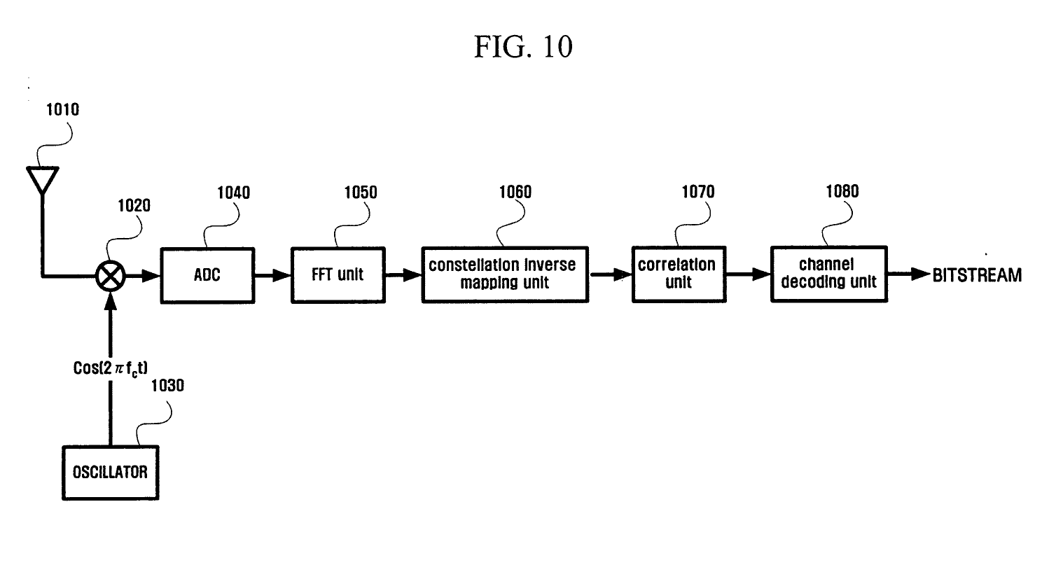

FIG. 10 is a functional block diagram of a UWB receiver according to an exemplary embodiment of the present invention.

The UWB receiver includes an antenna 1010 receiving a UWB signal transmitted via a wireless medium, an oscillator 1030 generating a sine wave corresponding to a central frequency of the received UWB signal, a mixer 1020 extracting an OFDM signal from the received UWB signal, an analog-to-digital converter (ADC) 1040 converting the OFDM signal from analog form to digital form, a FFT unit 1050 Fourier transforming the digital OFDM signal, a constellation inverse mapping unit 1060 obtaining a codeword of the received UWB signal using constellation inverse mapping, a correlation unit 1070 obtaining a coded bitstream corresponding to the codeword, and a channel decoding unit 1080 obtaining a bitstream by channel decoding the coded bitstream.

In operations of the UWB receiver, a UWB signal received at the antenna 1010 is converted to an OFDM signal using UWB demodulation. In the UWB demodulation, a sine wave with frequency identical to a central frequency of the UWB signal is generated and is mixed with the UWB signal, thereby obtaining the OFDM signal.

The OFDM signal is converted to a digital OFDM signal. The digital OFDM signal is converted from serial form into parallel form and is then sequentially subjected to 512-point FFT and constellation inverse mapping. Through the constellation inverse mapping, a codeword stream is obtained. A channel-coded bitstream is obtained from the codeword stream. The channel-coded bitstream is channel decoded, thereby obtaining a bitstream.

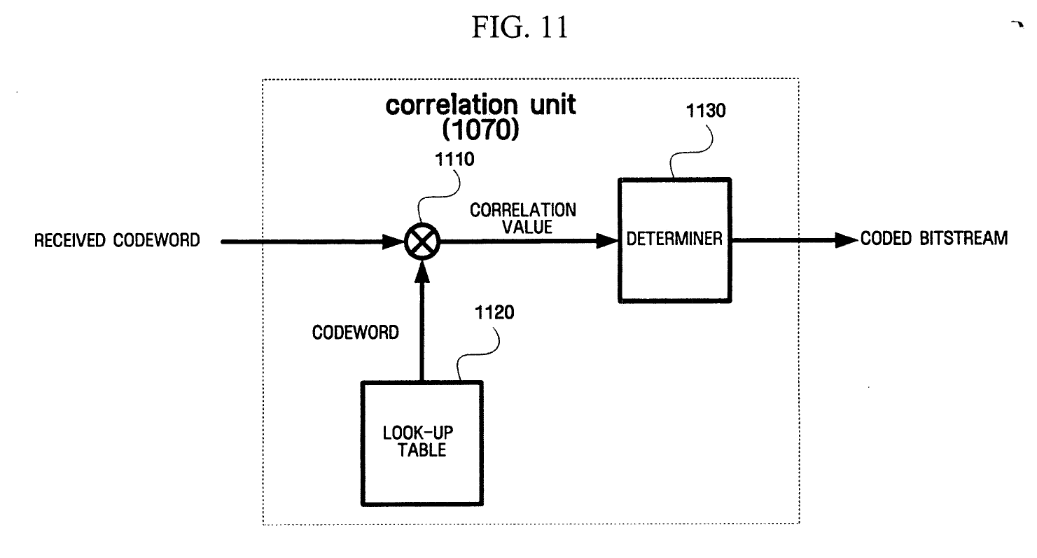

The correlation unit 1070 obtaining the channel-coded bitstream from the codeword stream will be described in detail with reference to FIG. 11 below.

FIG. 11 is a detailed functional block diagram of the correlation unit 1070 shown in FIG. 10.

The correlation unit 1070 receives codewords (i.e., a codeword stream) and outputs a coded bitstream. For this operation, the correlation unit 1070 includes a look-up table 1120, a correlation value extractor 1110, and a determiner 1130. A codeword input to the correlation unit 1070 is multiplied by one codeword stored in the look-up table 1120 in the correlation value extractor 1110. The correlation value extractor 1110 integrates a product of the two codewords, thereby obtaining a correlation value. The determiner 1130 determines the two codewords identical when the correlation value exceeds a predetermined positive value and determines the two codewords different when the correlation value does not exceed the predetermined positive value. Alternatively, if the received codeword has been subjected to BOK, the determiner 1130 determines the two codewords identical when the correlation value exceeds a predetermined positive value, determines the two codewords having a phase difference of 180 degrees when the correlation value is less than a predetermined negative value, and determines the two codewords different when the correlation value is between the predetermined positive value and the predetermined negative value. When the determiner 1130 finds a codeword identical to the received codeword, it outputs coded bits corresponding to the codeword. As such, received codewords are output in the form of a bitstream by the correlation unit 1070.

Referring back to FIG. 7, a serial channel-coded bitstream is converted to a parallel form and is input to the look-up table 720 in parallel. Then, the parallelly converted bitstream is converted to M-BOK signals (i.e., codewords) used to generate a UWB signal in each band. The codewords are combined to have an appropriate number of chips according to a type of modulation, thereby generating a constellation-mapped signal. The constellation-mapped signal is subjected to 512-point IFFT, thereby generating an OFDM signal. The OFDM signal is mixed with a carrier, thereby generating a UWB signal.

Although exemplary embodiments of the present invention have been described in detail above, it will be understood that various changes and variations may be made by persons skilled in the art without departing from the scope and spirit of the invention. In the above-described exemplary embodiments of the present invention, a codeword is obtained using a look-up table and M-BOK. However, a codeword may be obtained using M-ary Orthogonal Keying without using BOK. Alternatively, a codeword may be obtained by multiplication of pseudo noise as in conventional mobile communication. Accordingly, the above-described exemplary embodiments are to be regarded in an illustrative rather than a restrictive sense in every respect, and all such modifications are intended to be included within the scope of present invention and defined only in accordance with the following claims and their equivalents.

The present invention can provide UWB communication having characteristics of both of MB OFDM and DS CDMA. Accordingly, both of an average power and an instantaneous power satisfy an output power limit and slow baseband processing is allowed in the UWB communication.

1. An Ultra Wideband (UWB) transmission method comprising:
generating a codeword stream by dividing a bitstream into n-bit sets and selecting codewords corresponding to the n-bit sets;
generating Orthogonal Frequency Division Multiplexing (OFDM) signals by performing OFDM modulation on the codeword stream; and
generating UWB signals having a predetermined central frequency by mixing the OFDM signals with carriers.

2. The UWB transmission method of claim 1, wherein each of the codewords included in the codeword stream is determined according to a combination of n bits, and the codewords are orthogonal to each other.

3. The UWB transmission method of claim 1, wherein each of the codewords included in the codeword stream is determined according to a combination of n-1 bits among n bits, the other one bit among the n bits is used to determine whether a phase of a codeword is inverted by 180 degrees, and the codewords are orthogonal to each other.

4. The UWB transmission method of claim 1, wherein the OFDM modulation uses Binary Phase Shift Keying (BPSK) for constellation mapping.

5. The UWB transmission method of claim 1, wherein the generating the UWB signals comprises:
generating the carriers having central frequencies of bands; and
mixing the OFDM signal with the carriers in the respective bands.

6. An Ultra Wideband (UWB) transmitter comprising:
a look-up table comprising codewords respectively corresponding to n-bit sets into which a bitstream is divided, wherein the codewords are orthogonal to each other;
an Orthogonal Frequency Division Multiplexing (OFDM) modulation unit which performs OFDM modulation on a codeword stream obtained from the bitstream using the look-up table to thereby generating OFDM signals;
a UWB modulation unit which generates carriers having a predetermined central frequency and mixes the OFDM signals with the carriers to thereby generating UWB signals; and
an antenna which emits the UWB signals to a wireless transmission medium.

7. The UWB transmitter of claim 6, wherein the OFDM modulation unit uses Binary Phase Shift Keying (BPSK) for constellation mapping.

8. The UWB transmitter of claim 6, wherein the UWB modulation unit comprises:
a sine wave generator which generates the carriers each of which has a central frequency of a band; and
a mixer which mixes the OFDM signals with the carriers to generate the UWB signals.

9. An Ultra Wideband (UWB) reception method comprises:
obtaining Orthogonal Frequency Division Multiplexing (OFDM) signals from received UWB signals;
obtaining a codeword stream by performing OFDM demodulation on the OFDM signals; and
obtaining a bitstream by selecting n bits corresponding to each of a plurality of codewords of the codeword stream.

10. The UWB reception method of claim 9, wherein the obtaining of the codeword-stream comprises:
generating a sine wave having a same frequency as a carrier of each of the received UWB signals; and
mixing the sine wave with the UWB signals.

11. The UWB reception method of claim 9, wherein the OFDM signals are generated through constellation mapping based on Binary Phase Shift Keying (BPSK).

12. The UWB reception method of claim 9, wherein the obtaining the bitstream comprises:
obtaining a correlation value by multiplying a first codeword comprised in the codeword stream by a second codeword comprised in a look-up table and integrating a result of multiplication;
comparing the correlation value with a predetermined value; and
outputting n bits corresponding to the codeword in the look-up table if it is determined that the first and second codewords are identical.

13. An Ultra Wideband (UWB) receiver comprising:
an antenna which receives UWB signals transmitted through a wireless transmission medium;
a UWB demodulation unit obtaining Orthogonal Frequency Division Multiplexing (OFDM) signals from the UWB signals;
an OFDM demodulation unit obtaining a codeword stream from the OFDM signals; and
a correlation unit obtaining a bitstream from the codeword stream.

14. The UWB receiver of claim 13, wherein the UWB demodulation unit comprises:
a sine wave generator generating a sine wave having the same frequency as a carrier of each of the received UWB signals; and
a mixer mixing the sine wave with the UWB signals.

15. The UWB receiver of claim 13, wherein the OFDM signals are generated through constellation mapping based on Binary Phase Shift Keying (BPSK).

16. The UWB receiver of claim 13, wherein the correlation unit selects n bits corresponding to each of codewords comprised in the codeword stream, and the correlation unit comprises:
a look-up table which stores codewords to be multiplied by the codewords of the codeword stream;
a correlation value extractor which multiplies a first codeword of the codeword stream by a second codeword stored in the look-up table and integrating a result of the multiplication, thereby obtaining a correlation value; and
a determiner which compares the correlation value with a predetermined value to determine whether the first and second codewords are identical, and outputting n bits corresponding to the codeword in the look-up table if the first and second codewords are determined as being identical.

17. A computer-readable recording medium, on which a program for performing an Ultra Wideband (UWB) transmission method is recorded, the method comprising:
generating a codeword stream by dividing a bitstream into n-bit sets and selecting codewords corresponding to the n-bit sets;
generating Orthogonal Frequency Division Multiplexing (OFDM) signals by performing OFDM modulation on the codeword stream; and
generating UWB signals having a predetermined central frequency by mixing the OFDM signals with carriers.

18. The computer-readable recording medium of claim 17, wherein each of the codewords included in the codeword stream is determined according to a combination of n bits, and the codewords are orthogonal to each other.

19. The computer-readable recording medium of claim 17, wherein each of the codewords included in the codeword stream is determined according to a combination of n−1 bits among n bits, the other one bit among the n bits is used to determine whether a phase of a codeword is inverted by 180 degrees, and the codewords are orthogonal to each other.

20. The computer-readable recording medium of claim 17, wherein the OFDM modulation uses Binary Phase Shift Keying (BPSK) for constellation mapping.

21. The computer-readable recording medium of claim 17, wherein the generating the UWB signals comprises:
generating the carriers having central frequencies of bands; and
mixing the OFDM signal with the carriers in the respective bands.

22. A computer-readable recording medium, on which a program for performing an Ultra Wideband (UWB) reception method is recorded, the method comprising:
obtaining Orthogonal Frequency Division Multiplexing (OFDM) signals from received UWB signals;
obtaining a codeword stream by performing OFDM demodulation on the OFDM signals; and
obtaining a bitstream by selecting n bits corresponding to each of a plurality of codewords of the codeword stream.

23. The computer-readable recording medium of claim 22, wherein the obtaining of the codeword stream comprises:
generating a sine wave having a same frequency as a carrier of each of the received UWB signals; and
mixing the sine wave with the UWB signals.

24. The computer-readable recording medium of claim 22, wherein the OFDM signals are generated through constellation mapping based on Binary Phase Shift Keying (BPSK).

25. The computer-readable recording medium of claim 22, wherein the obtaining the bitstream comprises:
obtaining a correlation value by multiplying a first codeword comprised in the codeword stream by a second codeword comprised in a look-up table and integrating a result of multiplication;
comparing the correlation value with a predetermined value; and
outputting n bits corresponding to the codeword in the look-up table if it is determined that the first and second codewords are identical.
